(19) United States
(12) Patent Application Publication
(10) Pub. No.: US 2015/0295809 A1
(43) Pub. Date: Oct. 15, 2015

(54) COMMUNICATION SYSTEM

(71) Applicant: NEC CORPORATION, Minato-ku, Tokyo (JP)

(72) Inventor: Misao Fukuda, Tokyo (JP)

(21) Appl. No.: 14/646,921

(22) PCT Filed: Nov. 6, 2013
(86) PCT No.: PCT/JP2013/006538

§ 371 Date: May 22, 2015

(30) Foreign Application Priority Data
Nov. 26, 2012 (JP) 2012-257615

(51) Int. Cl. H04L 12/26; H04W 4/22

(52) U.S. Cl. CPC H04L 43/10; H04W 4/22

(57) ABSTRACT

A communication system in the present invention has a plurality of information processing devices each executing communication control processing on user terminals connected via a network, and the communication system includes: an outside situation information acquiring unit which acquires outside situation information representing a preset outside situation of a place where the information processing device is installed; and a communication control unit which instructs so that the communication control processing executed on the user terminals by a predetermined one of the information processing devices is executed by another one of the information processing devices, on the basis of the outside situation information acquired by the outside situation information acquiring unit.

### TECHNICAL FIELD

The present invention relates to a communication system. In particular, the present invention relates to a communication system which provides a service to a user terminal connected thereto via an IP network.

### BACKGROUND ART

There is a known communication system that includes an information processing unit relaying communication between a user terminal connected thereto via an IP (Internet Protocol) network and another user terminal to which the user terminal wants to be connected. For example, Patent Document 1 describes that a communication system includes a SIP (Session Initiation Protocol) server as an information processing unit. Further, there is a known technique in which a server for realizing UC (Unified Communication) is included as an information processing unit.

Patent Document 1: Japanese Unexamined Patent Application Publication No. JP-A 2006-287697

In the communication system, the operating ratio of the information processing unit may increase or decrease depending on given factors. For example, in a daytime period, the number of the users of the information processing unit is large, and hence, the operating ratio of the information processing unit is high. On the other hand, in a night-time period, the number of the users of the information processing unit is small, and hence, the operating ratio of the information processing unit is low. Thus, the information processing unit is much used and congestion or the like might occur in a daytime period, whereas the information processing unit is hardly used in a night-time period. As a result, there is a problem that the use efficiency of the information processing unit gets low.

### SUMMARY

Accordingly, an object of the present invention is to provide a communication system which can solve the abovementioned problem that it is impossible to improve the use efficiency of the information processing unit.

In order to achieve the object, a communication system as an aspect of the present invention has a plurality of information processing devices each executing communication control processing on user terminals connected via a network, and the communication system includes:

an outside situation information acquiring unit which acquires outside situation information representing a preset outside situation of a place where the information processing device is installed; and

a communication control unit which instructs so that the communication control processing executed on the user terminals by a predetermined one of the information processing devices is executed by another one of the information processing devices, on a basis of the outside situation information acquired by the outside situation information acquiring unit.

Further, an information processing device as another aspect of the present invention includes:

an outside situation information acquiring unit which acquires outside situation information representing a preset outside situation of a place where the information processing device is installed; and

a communication control unit which instructs so that communication control processing executed by the information processing device on user terminals connected via a network is executed by another information processing device, on a basis of the outside situation information acquired by the outside situation information acquiring unit.

Further, an information processing method as another aspect of the present invention includes:

acquiring outside situation information representing a preset outside situation of a place where an information processing device is installed; and

instructing so that communication control processing executed by the information processing device on user terminals connected via a network is executed by another information processing device, on a basis of the acquired outside situation information.

Further, a computer program as another aspect of the present invention is a computer program including instructions for causing an information processing device to realize:

an outside situation information acquiring unit which acquires outside situation information representing a preset outside situation of a place where the information processing device is installed; and

a communication control unit which instructs so that communication control processing executed by the information processing device on user terminals connected via a network is executed by another information processing device, on a basis of the outside situation information acquired by the outside situation information acquiring unit.

With the configurations as described above, the present invention can improve the use efficiency of the information processing unit.

### BRIEF DESCRIPTION OF DRAWINGS

FIG. 1 a view showing the configuration of a communication system according to a first exemplary embodiment of the present invention;

FIG. 2 is a block diagram showing the function of an information processing device according to the first exemplary embodiment of the present invention;

FIG. 3 is a block diagram showing the function of a connection control part according to the first exemplary embodiment of the present invention;

FIG. 4 is a view for describing an example of a time-difference management table;

FIG. 5 is a view for describing an example of an information processing unit management table;

FIG. 6 is a view for describing an example of a group management table;

FIG. 7 is a view for describing an example of an event management table;

FIG. 8 is a flowchart for describing information processing unit specification processing;

FIG. 9 is a view describing the overview of the operation of the communication system;

FIG. 10 is a sequence diagram showing the operation of the communication system;

FIG. 11 is a flowchart for describing operating status judgment processing; and

FIG. 12 is a block diagram showing the function of a communication system according to a second exemplary embodiment of the present invention.

### EXEMPLARY EMBODIMENTS

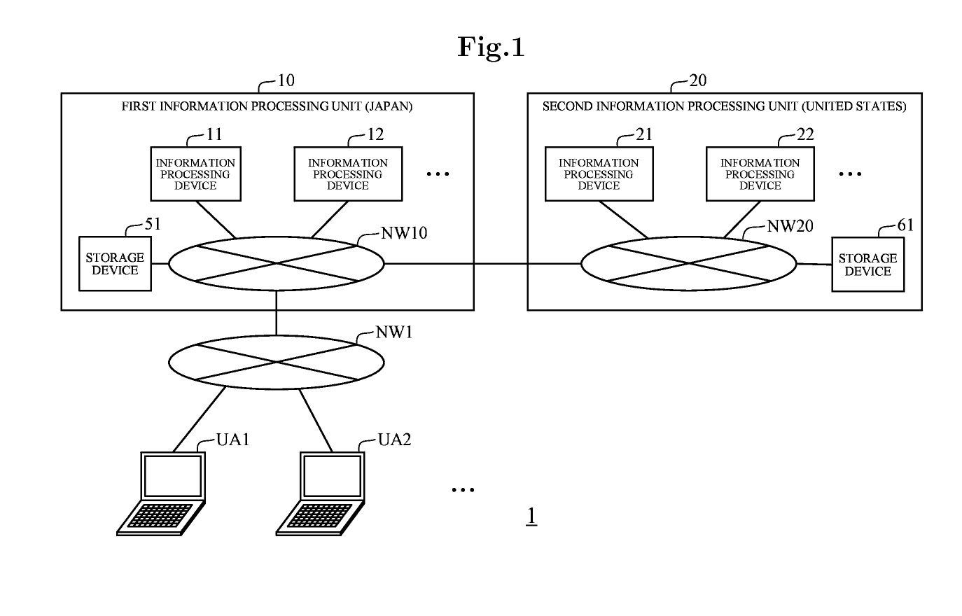

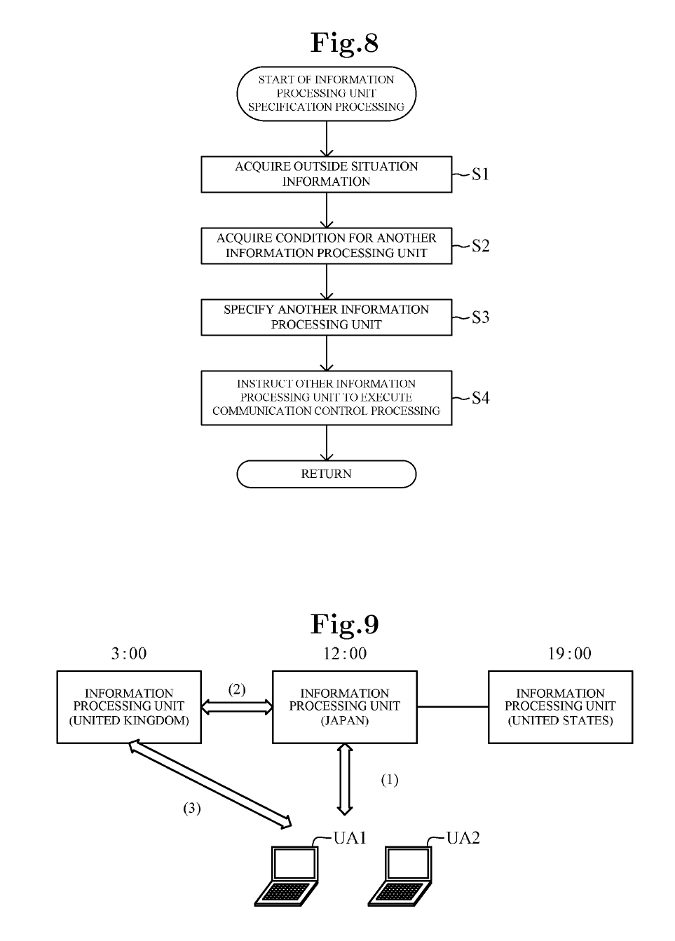

Below, an exemplary embodiment of a communication system 1 according to the present invention will be described referring to FIGS. 1 to 11. FIGS. 1 to 7 are views for describing the configuration of the communication system 1. FIGS. 8 to 11 are views for describing the operation of the communication system 1.

### First Exemplary Embodiment

### Configuration

As shown in FIG. 1, the communication system 1 according to a first exemplary embodiment has a plurality of information processing units including a first information processing unit 10 and a second information processing unit 20. For example, the first information processing unit 10 is an information processing unit placed in a first country (for example, Japan). Moreover, for example, the second information processing unit 20 is an information processing unit placed in a second country (for example, the United States) which is different from the first country. Definitely, the information processing units 10 and 20 are not limited to be placed in the abovementioned manner and may be placed in the same country (for example, Japan). Further, the communication system 1 is not limited to include two information processing units and may include three or more information processing units.

The first information processing unit 10 includes a plurality of information processing devices 11, 12, . . . and a storage device 51. The information processing devices 11, 12, . . . are connected so as to be capable of communicating via a first unit communication network NW10. In this exemplary embodiment, each of the information processing devices 11, 12, . . . is a blade server. The first information processing unit 10 includes the information processing devices 11, 12, . . . , but may be configured by one information processing device (for example, the information processing device 11). In other words, one information processing device may have a configuration for realizing each function part of the first information processing unit 10 to be described later. Moreover, another information processing unit to be described below may also be configured by one information processing device. A plurality of user terminals UA1, UA2, . . . are connected to the first unit communication network NW10 via a user communication network NW1.

Likewise, the second information processing unit 20 includes a plurality of information processing devices 21, 22, . . . and a storage device 61. The information processing devices 21, 22, . . . are connected so as to be capable of communicating via a second unit communication network NW20. Each of the information processing devices 21, 22, . . . is a blade server. Below, the first information processing unit 10 (hereinafter, described as the information processing unit 10), that is, the information processing devices 11, 12, . . . and the storage device 51 will be described. The second information processing unit 20, that is, the information processing devices 21, 22, . . . and the storage device 61 have the same configurations as in the first information processing unit 10.

Each of the information processing devices 11, 12, . . . is configured to be able to build a plurality of virtual machines (virtual servers). To be specific, each of the information processing devices 11, 12, . . . executes a program (main OS) serving as a primary OS (Operating System).

Further, each of the information processing devices 11, 12, . . . executes a virtual machine program that is a program for causing the virtual machines to operate on the main OS. Besides, each of the information processing devices 11, 12, . . . executes at least one secondary OS (guest OS) on the virtual machine program.

In addition, each of the information processing devices 11, 12, . . . executes at least one application program on each of the guest OSs. The guest OS executed by each of information processing devices 11, 12, . . . configures the virtual machine. Each of the virtual machines realizes one of the function parts to be described later.

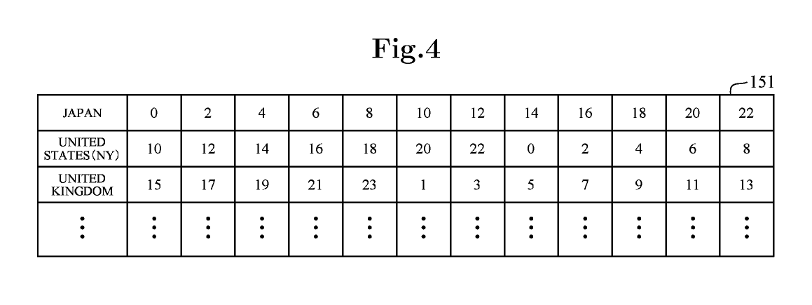

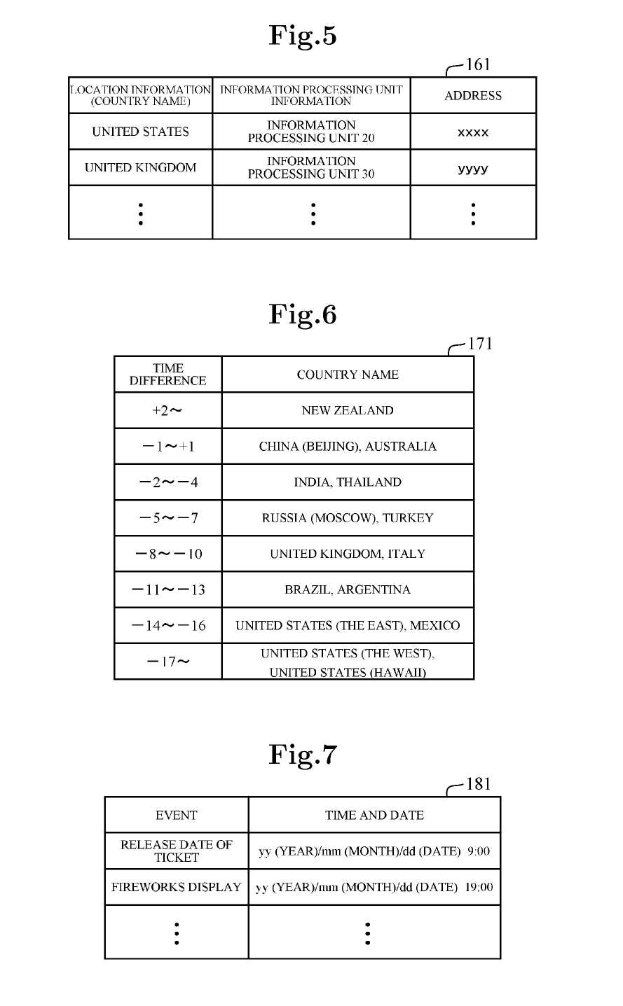

The storage device 51 includes a hard disk drive, a non-volatile memory, and the like. The storage device 51 stores a time-difference management table 151 (FIG. 4), an information processing unit management table 161 (FIG. 5), a group management table 171 (FIG. 6), and an event management table 181 (FIG. 7). The details of the respective tables will be described later.

Each of the user terminals UA1, UA2, . . . is, for example, a personal computer or a smartphone. Meanwhile, each of the user terminals UA1, UA2, . . . may be a mobile phone terminal, a PHS (Personal Handyphone System), a PDA (Personal Data Assistance, Personal Digital Assistant), a car navigation terminal, a game terminal, or the like.

The user terminals UA1, UA2, . . . are connected so as to be able to communicate via the user communication network NW1. The user communication network NW1 and the unit communication network NW10 are connected to each other. The user communication network NW1 and the unit communication networks NW10 and NW20 are configured by a communication network such as an IP network.

Each of the user terminals UA1, UA2, . . . includes a central processing unit (CPU), a storage device (a memory and a hard disk drive device (HDD)), an input device (in this exemplary embodiment, a plurality of key buttons) and an output device (in this exemplary embodiment, a display), which are not shown in the drawings. Each of the user terminals UA1, UA2, . . . is configured to realize a function to be described later by the CPU's execution of a program stored in the storage device.

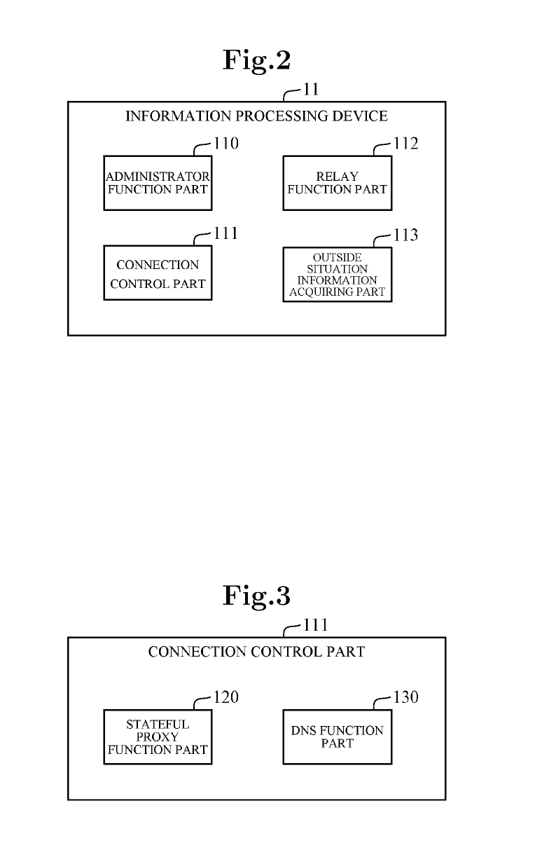

Next, referring to FIGS. 2 and 3, the configuration of the information processing unit (each of the information processing devices) will be described. As shown in FIG. 2, the function of the information processing device 11 (the information processing unit 10) includes an administrator function part 110 (a communication control unit), a connection control part 111, a relay function part 112, and an outside situation information acquiring part 113 (an outside situation information acquiring unit). Moreover, as shown in FIG. 3, the connection control part 111 includes a stateful proxy function part 120 and a DNS (Domain Name (Naming) System (Server)) function part 130. The connection control part 111 is, for example, a SIP (Session Initiation Protocol) server, and controls connection between a plurality of user terminals. The relay function part 112 is, for example, a server for realizing UC, and relays communication between a plurality of user terminals. The details of the connection control part 111 and the relay function part 112 will be described later. The information processing unit 10 may include at least either the connection control part 111 or the relay function part 112.

Firstly, a process of instructing another information processing unit to execute communication control processing in accordance with outside situation information will be described. The outside situation information acquiring part 113 acquires outside situation information. Outside situation information is information which represents time in a place where the information processing unit (itself) is installed, an outside situation (an accident, a disaster, and the like) which has occurred in the place where the information processing unit is installed, or an outside situation (an event, and so on) which is expected to occur in the place where the information processing unit is installed. Then, the administrator function part 110 specifies another information processing unit on the basis of the outside situation information acquired by the outside situation information acquiring part 113, and instructs the specified other information processing unit to execute the communication control processing. A specific description will be made below.

The outside situation information acquiring part 113 acquires outside situation information of the place where the information processing unit 10 (a predetermined information processing device) is installed. For example, the outside situation information acquiring part 113 acquires current time in the place where the information processing unit 10 is installed as outside situation information. The outside situation information acquiring part 113 may acquire the current time by referring to a clock built in the information processing unit 10 itself, or may acquire the current time from a time server distributing time, or the like. Further, the outside situation information acquiring part 113 acquires location information representing the place where the information processing unit 10 is installed. The location information of the information processing unit 10 is stored in, for example, the storage device 51 in advance. It is assumed as an example that the outside situation information acquiring part 113 acquires a given place in Japan as location information and acquires current time “12:00” as outside situation information. In this case, the time “12:00” is in a daytime period (for example, “9:00 to 17:00”). Therefore, the administrator function part 110 acquires a night-time period (for example, “0:00 to 5:00,” “21:00 to 23:00”) as a condition for another information processing unit.

Then, the administrator function part 110 specifies another information processing unit that meets the acquired condition. To be specific, firstly, the administrator function part 110 refers to the time-difference management table 151 (FIG. 4) stored in the storage device 51, and specifies a place (a country) where it is in a night-time period when it is “12:00” in Japan. FIG. 4 is a view showing an example of the time-difference management table 151. The time-difference management table 151 shows a time-difference relation between time in the place where the information processing unit 10 is installed (for example, Japan) and a place where another information processing unit is installed (for example, the United States and the United Kingdom).

The administrator function part 110 refers to the time-difference management table 151 and specifies the “United Kingdom” where it is “3:00” when it is “12:00” in Japan, as a country where it is in a night-time period. Consequently, the administrator function part 110 specifies an information processing unit installed in the “United Kingdom,” as another information processing unit. Next, the administrator function part 110 refers to information processing unit information of the “United Kingdom” previously stored in the information processing unit management table 161 shown in FIG. 5, and acquires information such as an address “yyyy” for communicating with an “information processing unit 30” of the “United Kingdom.” FIG. 5 is a view showing an example of the information processing unit management table 161. The information processing unit management table 161 stores information of another information processing unit installed in a different place from the place where the information processing unit 10 is installed. The administrator function part 110 acquires information such as an address for communicating with an information processing unit installed in a country identified by a country name, together with information processing unit information. In the information processing unit management table 161, one information processing unit is linked to one country, but a plurality of information processing units may be linked to one country.

Then, the administrator function part 110 instructs the specified other information processing unit to execute the communication control processing on the user terminals UA1, UA2, . . . on the basis of the acquired information processing unit information. Consequently, it is possible to use an information processing unit most of whose equipment is idle in the night-time period. Therefore, it is not necessary to spend money on the equipment of the information processing unit 10, it is possible to reduce the cost of each of the information processing units, and it is possible to decrease a fee for a service provided to the user. Moreover, it is possible to increase the use efficiency of the information processing units.

Further, the outside situation information acquiring part 113 acquires time (outside situation information) in a place where another information processing unit is installed at preset timing (for example, at regular intervals). For example, the outside situation information acquiring part 113 acquires time in a place where another information processing unit is installed, which is transmitted from the other information processing unit. Meanwhile, the outside situation information acquiring part 113 may refer to the information processing unit management table 161 shown in FIG. 5 and acquire time in a place where another information processing unit is installed by communicating with the other information processing unit. Then, in a case where time in a place where another information processing unit is installed is in a night-time period, the administrator function part 110 can instruct the other information processing unit to execute the communication control processing.

Further, the administrator function part 110 can acquire a condition for another information processing unit on the basis of a preset calculation criterion. For example, the administrator function part 110 adds “12 hours” to (or subtracts “12 hours” from) the current time “12:00” acquired as the outside situation information of the information processing unit 10, and acquires the calculated time “0:00” as a condition for another information processing unit. Then, the administrator function part 110 specifies an information processing unit installed in a place (a country) where current time is “0:00,” as another information processing unit. Alternatively, the administrator function part 110 may acquire time within a predetermined range (for example, ±2 hours) from the time “0:00” obtained by adding “12 hours” to (or subtracting “12 hours” from) the acquired time “12:00,” as a condition for another information processing unit. Then, the administrator function part 110 specifies an information processing unit installed in a place where current time is included in a range of “22:00 to 23:59” or a range of “0:00 to 2:00,” as another information processing unit.

Furthermore, the administrator function part 110 can classify information processing units in the world into a plurality of groups depending on places and specify a predetermined information processing unit in the classified groups. FIG. 6 is a view for describing the group management table 171. The group management table 171 shows information that the information processing units of the respective countries are grouped in accordance with a time difference from time in the place where the information processing unit 10 is installed (Japan). For example, in the group management table 171, “New Zealand” is stored as a country where a time difference from time in Japan is equal to or more than “+2 hours.” Moreover, in the group management table 171, “China (Beijing) and Australia” are stored as countries where time differences from time in Japan are within a range “from −1 hour to +1 hour.” Likewise, the group management table 171 has information that places (countries) where information processing units are installed are classified into the same group every three hours, for example. However, a grouping method is not limited to the abovementioned one.

The administrator function part 110 refers to the group management table 171 and specifies another information processing unit from any of the classified groups. For example, in a case where it is in a time period of “10:00 to 12:00” in Japan, the administrator function part 110 specifies an information processing unit from a group of “the United Kingdom and Italy” where it is in a time period of “0:00 to 2:00” (a night-time period). Moreover, for example, in a case where it is in a time period of “16:00 to 18:00” in Japan, the administrator function part 110 specifies an information processing unit from a group of “the United States (the East) and Mexico” where it is in a time period of “0:00 to 2:00.” By thus grouping and managing the information processing units, the administrator function part 110 can specify a more appropriate other information processing unit depending on time.

In a case where there are a plurality of candidates of another information processing unit as described above, the administrator function part 110 acquires the operating status of each of the information processing units from the (administrator function part 110 of the) information processing unit, and specifies another information processing unit. For example, the administrator function part 110 specifies an information processing unit in which no failure has occurred and a load on which is the minimum, as another information processing unit on the basis of the acquired operating status. Moreover, the outside situation information acquiring part 113 may set the order of priorities of the candidates of another information processing unit and specify an information processing unit with a higher priority as another information processing unit.

Next, a case of acquiring information which is different from time as outside situation information will be described. For example, the outside situation information acquiring part 113 acquires, as outside situation information, an outside situation which has occurred or which is expected to occur in the place where the information processing unit 10 is installed. Herein, an outside situation which has occurred in the place where the information processing unit 10 is installed is, for example, an accident, an incident, a disaster and the like. Moreover, an outside situation which is expected to occur in the place where the information processing unit 10 is installed is, for example, an event. To be specific, an event is, for example, the start of the reservation or sale of tickets, an international convention such as the Olympics, a fireworks display and the like. When there is a fear that such an outside situation causes a rise in the load on the information processing unit 10 or causes a failure in the information processing unit 10, the outside situation information acquiring part 113 executes processing for specifying another information processing unit.

FIG. 7 is a view for describing the event management table 181. The event management table 181 stores, for example, the content of an event which will possibly occur in the place where the information processing unit 10 is installed and the time and date of the event (outside situation information). For example, the outside situation information acquiring part 113 can update the content of an event and the time and date of the event stored in the event management table 181 by getting connected to an event management server which manages events and so on via a communication network such as the Internet and acquiring event information.

The outside situation information acquiring part 113 refers to the event management table 181 shown in FIG. 7 and acquires an outside situation (an event) which is expected to occur in the place where the information processing unit 10 is installed. Subsequently, the outside situation information acquiring part 113 acquires the time and date of the event from the event management table 181. Moreover, the outside situation information acquiring part 113 refers to the information processing unit management table 161 shown in FIG. 5 and communicates with another information processing unit. Then, the outside situation information acquiring part 113 acquires the content of an event which is expected to occur in a place where the other information processing unit is installed and the time and date of the event from the event management table 181 stored in the storage device of the other information processing unit. Meanwhile, the outside situation information acquiring part 113 may refer to the information processing unit management table 161 shown in FIG. 5, specify a place where the other information processing unit is installed, and acquire the content of an event in the specified place and the time and date of the event from the event management server. Thus, the outside situation information acquiring part 113 acquires outside situation information which varies depending on a place where the information processing unit is installed.

Then, when the outside situation information acquiring part 113 acquires the content of an event and the time and date of the event, the administrator function part 110 acquires a condition for another information processing unit. To be specific, when an event is held in the place where the information processing unit 10 is installed (equivalent to information representing an instruction target situation), the administrator function part 110 acquires a condition that an event is not held in a place where another information processing unit is installed. Next, the administrator function part 110 judges whether or not the time and date of the event of the information processing unit 10 acquired by the outside situation information acquiring part 113 coincides with the time and date of an event of the other information processing unit. In a case where the times and dates of the events do not coincide (not equivalent to the information representing the instruction target situation), that is, in a case where an event is not held in the place where the other information processing unit is installed when an event is held in the place where the information processing unit 10 is installed, the administrator function part 110 instructs the other information processing unit to execute the communication control processing.

Meanwhile, the outside situation information acquiring part 113 may acquire a place where it is in a night-time period at the acquired time and date of the event and acquire the time and date of an event from the other information processing unit installed in the acquired place. Then, the administrator function part 110 may judge whether or not the time and date of the event of the other information processing unit installed in acquired place coincides with the time and date of the event for the information processing unit 10.

Further, in a case where there are a plurality of candidates of another information processing unit, the administrator function part 110 can judge whether or not the time and date of an event of another information processing unit coincides with the time date of the event of the information processing unit 10 on the basis of the operating status acquired from the administrator function part 10 of each of the information processing units. For example, the outside situation information acquiring part 113 acquires the time and date of an event in order from the information processing unit having the minimum load. Thus, the administrator function part 110 can judge whether or not the time and date of an event of the other information processing unit coincides with the time date of the event of the information processing unit 10 in order that the outside situation information acquiring part 113 acquires the time and date of the event. Furthermore, in a case where there are a plurality of candidates of another information processing unit, the outside situation information acquiring part 113 can acquire the time and date of an event in order from the information processing unit having the highest priority on the basis of the order of priority previously set. Thus, the administrator function part 110 can judge whether or not the time and date of an event of the other information processing unit coincides with the time date of the event of the information processing unit 10 in order that the outside situation information acquiring part 113 acquires the time and date of the event.

Next, a case of acquiring outside situation information such as an accident, an incident, a disaster and the like will be described. The outside situation information acquiring part 113 refers to a previously stored URL (Uniform Resource Locator) and a server device which distributes information of an accident, an incident, a disaster and the like, via a communication network such as the Internet at given timing (for example, at regular intervals). Consequently, the outside situation information acquiring part 113 acquires outside situation information such as an accident, an incident, a disaster and the like having occurred in the place where the information processing unit 10 is installed. Alternatively, the outside situation information acquiring part 113 may use a device detecting a disaster, such as a seismograph, and acquire an outside situation having occurred in a place where an information processing unit is installed.

Next, the outside situation information acquiring part 113 acquires outside situation information having occurred in a place where another information processing unit is installed. To be specific, the outside situation information acquiring part 113 refers to the information processing unit management table 161 and communicates with another information processing unit. Then, the outside situation information acquiring part 113 receives outside situation information acquired by the outside situation information acquiring part 113 of the other information processing unit, thereby acquiring the outside situation information of the other information processing unit. Meanwhile, the outside situation information acquiring part 113 may acquire location information of a place where another information processing unit is installed and, by referring to the server device that distributes information of an accident, an incident, a disaster and the like, acquire outside situation information of the place where the other information processing unit is installed. The outside situation information acquiring part 113 may be configured not to acquire outside situation information in a case where no accident, incident, disaster or the like has occurred.

When the outside situation information acquiring part 113 acquires outside situation information such as an accident, an incident, a disaster and the like, the administrator function part 110 acquires a condition for another information processing unit. To be specific, when an accident, an incident, a disaster or the like has occurred in the place where the information processing unit 10 is installed (equivalent to information representing an instruction target situation), the administrator function part 110 acquires a condition that no accident, incident, disaster or the like has occurred in a place where another information processing unit is installed (or a condition that outside situation information of another information processing unit has not been acquired).

Then, the administrator function part 110 judges whether or not the acquired condition is satisfied on the basis of the outside situation information of the information processing unit 10 acquired by the outside situation information acquiring part 113 and the outside situation information of the other information processing unit. In other words, when an accident, an incident, a disaster or the like has occurred in the place where the information processing unit 10 is installed, the administrator function part 110 judges whether or not an accident, an incident, a disaster or the like has occurred in the place where the other information processing unit is installed. Then, in a case where no accident, incident, disaster or the like has occurred in the place where the other information processing unit is installed, the administrator function part 110 instructs the other information processing unit to execute the communication control process.

The outside situation information acquiring part 13 acquires time when an accident, an incident, a disaster or the like has occurred or the current time, and acquires a place where it is in a night-time period at the acquired time. Moreover, the administrator function part 110 may acquire an outside situation of the other information processing unit installed in the acquired place and judge whether or not an accident, incident, disaster or the like has occurred. Then, in a case where no accident, incident, disaster or the like has occurred, the administrator function part 110 can instruct the other information processing unit to execute the communication control process.

Further, in a case where there are a plurality of candidates of another information processing unit, the outside situation information acquiring part 113 acquires information of an accident, an incident, a disaster and the like on the basis of an operating status acquired from the administrator function part 110 of each of the information processing units. For example, the administrator function part 110 acquires information of an accident, an incident, a disaster and the like in order from the information processing unit having the minimum load. Then, when an accident, an incident, a disaster or the like has occurred in the place where the information processing unit 10 is installed, the administrator function part 110 can judge whether or not an accident, an incident, a disaster or the like has occurred in the place where the other information processing unit is installed. Furthermore, in a case where there are a plurality of candidates of another information processing unit, the outside situation information acquiring part 113 acquires information of an accident, an incident, a disaster and the like in order from the information processing unit having the highest priority on the basis of the order of priority previously set. Then, when an accident, an incident, a disaster or the like has occurred in the place where the information processing unit 10 is installed, the administrator function part 110 judges whether or not an accident, an incident, a disaster or the like has occurred in the place where the other information processing unit is installed.

Consequently, for example, in a case where a disaster or the like occurs in a night-time period, the outside situation information acquiring part 113 can specify another information processing unit (information processing device) which is in the same night-time period and instruct the other information processing unit installed in a place where a disaster or the like has not occurred to execute the communication control process.

Further, in a case where there are a plurality of candidates of another information processing unit as described above, the outside situation information acquiring part 113 may acquire an outside situation which has occurred or which is expected to occur in each of the places where the candidates of another information processing unit are installed. Then, the outside situation information acquiring part 113 may specify, as another information processing unit, an information processing unit which does not have the outside situations that have occurred or are expected to occur in the places where the information processing units are installed. In other words, the outside situation information acquiring part 113 can specify, as another information processing unit, an information processing unit whose load hardly increases or an information processing unit which hardly causes a failure.

Furthermore, in the case of instructing another information processing unit to execute the communication control process, the administrator function part 110 may instruct the other information processing unit to execute the whole communication control process or may instruct the other information processing unit to execute part of the communication control processing. In the case of instructing the other information processing unit to execute part of the communication control process, the administrator function part 110 can make the processing amount of the communication control process executed by the information processing unit 10 equal to the processing amount of the communication control process executed by the other information processing unit. Definitely, the administrator function part 110 is not limited to make the processing amount of the communication control process executed by the information processing unit 10 equal to the processing amount of the communication control process executed by the other information processing unit. For example, the administrator function part 110 can be configured to distribute a preset ratio of the processing amount of the communication control process to the other information processing unit in accordance with the scale of an event or the scale of a disaster or the like acquired by the outside situation information acquiring part 113.

Next, the communication control processing for controlling communication among the user terminals UA1, UA2, . . . will be described. The administrator function part 110 manages the connection control part 111 (to be specific, the stateful proxy function part 120 and the DNS function part 130) and the relay function part 112. Moreover, the administrator function part 110 acquires an IP address assigned to each of the built virtual machines, information representing a load on each of the virtual machines, an IP address assigned to the virtual machine configuring the relay function part 112, an IP address assigned to the virtual machine configuring the stateful proxy function part 120, identification information (for example, ID (Identification) and a telephone number) and an IP address which are for identifying each of the user terminals UA1, UA2, . . . in the session established state, and so on, and retains the acquired information.

Further, the administrator function part 110 acquires an operating status of the information processing unit 10 (the connection control part 111 and the relay function part 112). Then, depending on the acquired operating status, the administrator function part 110 instructs another information processing unit (for example, the second information processing unit 20) to execute the communication control processing on the user terminals UA1, UA2, . . . . In other words, the administrator function part 110 instructs so that the communication control processing on the user terminals UA1, UA2, . . . to be executed by a predetermined information processing unit (information processing device) is executed by another information processing unit (another information processing device).

For example, the administrator function part 110 acquires load information representing a load on the connection control part 111, as the operating status. A load is, for example, the use rates of hardware resources such as a CPU and a memory. In a case where a load represented by the acquired load information is larger than a predetermined first load threshold, the administrator function part 110 instructs (the connection control part 111 included by) another information processing unit to execute the communication control processing. Another information processing unit is specified in a process of specifying another information processing unit on the basis of the outside situation information described above. Thus, it is possible to securely avoid occurrence of congestion.

Further, the administrator function part 110 detects occurrence of a failure (acquires the presence or absence of occurrence of a failure) in the connection control part 111, as the operating status. In the case of detecting occurrence of a failure in the connection control part 111, the administrator function part 110 instructs another information processing unit to execute the communication control processing. Thus, it is possible to securely connect the user terminals UA1, UA2, . . . .

Likewise, the administrator function part 110 acquires load information representing a load on the relay function part 112, as the operating status. In a case where a load represented by the acquired load information is larger than a predetermined second load threshold, the administrator function part 110 instructs (the relay function part 112 included by) another information processing unit to execute the communication control processing. Moreover, the administrator function part detects occurrence of a failure in the relay function part 112, as the operating status. In the case of detecting occurrence of a failure in the relay function part 112, the administrator function part 110 instructs another information processing unit to execute the communication control processing.

Further, the administrator function part 110 communicates with the administrator function part 110 of another information processing unit (for example, the second information processing unit 20) and transmits and receives the operating status. The operating status transmitted and received by the administrator function part 110 includes at least one of a load on the information processing unit, the load threshold, and the presence or absence of a failure. Then, the administrator function part 110 stores the acquired operating status into a storage device (or a database). Thus, for example, in a case where congestion occurs because of increase of the load on the information processing unit 10, it is possible to instantly select another processing unit that can avoid congestion and immediately avoid occurrence of congestion. Moreover, for example, in a case where a failure has occurred in the information processing unit 10, it is possible to instantly select another information processing unit where a failure has not occurred, and relay communication among the user terminals UA1, UA2, . . . immediately and securely.

The administrator function part 110 may be always connected to the administrator function part of another information processing unit or may be connected to the administrator function part of another information processing unit every time a preset time passes to transmit and receive the operating status. Moreover, for example, in the case of selecting another information processing unit, the administrator function part 110 may select another information processing unit having the minimum load, or may select another information processing unit whose communication distance is the shortest among other information processing units that can avoid congestion.

Further, the user terminals UA1, UA2, . . . each transmit a connection request notice to the information processing unit 10 on the basis of information inputted by the user. Then, the administrator function part 110 receives the connection request notice transmitted by the user terminal UA1, UA2, . . . . The user terminal UA1, UA2, . . . which is a transmission source (namely, a communication source) of a connection request notice is also called a communication source user terminal. Moreover, a connection request notice includes identification information for identifying a communication destination (for example, a user terminal (a communication destination user terminal) and the relay function part 112).

The administrator function part 110 transmits (outputs) identification information included in a received connection request notice to the connection control part 111 (the stateful proxy function part 120). The stateful proxy function part 120 receives the identification information transmitted by the administrator function part 110. The stateful proxy function part 120 transmits (outputs) the received identification information to the DNS function part 130.

The stateful proxy function part 120 receives an IP address transmitted by the DNS function part 130 as a communication destination IP address. The stateful proxy function part 120 establishes a session between the received communication destination IP address and a communication source IP address which is an IP address assigned to a communication source user terminal, according to the SIP. Moreover, the stateful proxy function part 120 transmits the communication destination IP address to the communication source user terminal. In a case where the communication source user terminal and the communication destination user terminal are connected via the relay function part 112 (in a case where the communication destination IP address is the IP address of the relay function part 112), it is possible to omit the process that the stateful proxy function part 120 establishes a session.

In a case where, when a session is established by the stateful proxy function 120 and user terminals are communicating with each other, a connection request notice is transmitted by another user terminal to the communicating user terminal (for example, the user terminal UA1), the administrator function part 110 can notify the other user terminal that the user terminal is communicating. For example, in a case where, when a session is established between the user terminal UA1 and the user terminal UA2 and the user terminals are in the middle of a call (in the middle of communication) with each other, a call is made (a connection request notice is transmitted) by another user terminal to the user terminal UA1, the administrator function part 110 transmits a busy tone representing that the user terminal is in the middle of a call to the other user terminal. Information representing that a user terminal is in the middle of communication (for example, a busy tone) is previously stored in a storage device.

The DNS function part 130 stores identification information and an IP address assigned to the identification information so as to be associated with each other. The DNS function part 130 receives identification information transmitted by the stateful proxy function part 120. The DNS function part 130 transmits (outputs) an IP address stored so as to be associated with the received identification information to the stateful proxy function part 120 having transmitted the identification information.

Each of the user terminals UA1, UA2, . . . transmits a connection request notice to the information processing unit 10 on the basis of information inputted by a user. Moreover, each of the user terminals UA1, UA2, . . . receives a communication destination IP address from the information processing unit 10. Each of the user terminals UA1, UA2, . . . communicates with the user terminal UA1, UA2, . . . to which the received communication destination IP address is assigned, via a session established by the information processing unit 10. Consequently, the user of the user terminal UA1, UA2, . . . can transmit and receive predetermined information.

Further, when receiving the communication destination IP address of the relay function part 112 from the information processing unit 10, each of the user terminals UA1, UA2, . . . transmits a server connection request including the received communication destination IP address to the information processing unit 10 (the administrator function part 110). The administrator function part 110 transmits (outputs) the communication destination IP address included in the server connection request received from the user terminal UA1, UA2, . . . and the IP address of the communication source user terminal, to the relay function part 112.

The relay function part 112 is, for example, a server for realizing UC, and includes various communication means and realizes efficient communication by integrating the communication means. A communication means is, for example, a WEB conference, a TV (Television) conference, a multi-point conference, a chat, an IVR (Interactive Voice Response), a contact center, or the like.

The relay function part 112 receives an IP addresses transmitted by the administrator function part 110. Then, the relay function part 112 is connected to the user terminal UA1, UA2, . . . on the basis of the received IP addresses (for example, a communication source IP address and a communication destination IP address). Then, the relay function part 112 provides a communication means selected by the user terminal UA2, UA2, . . . to the user terminal UA, UA2, . . . . Consequently, the user of the user terminal UA1, UA2, . . . can communicate predetermined information.

The communication system 1 can be equipped with, for example, a spare administrator function part outside the information processing unit (in a place away from the information processing unit), for BCP (Business Continuity Plan). Consequently, when an unexpected event such as a disaster or an accident occurs, it is possible to immediately restore the function of the administrator function part by using the external administrator function part. Moreover, the communication system 1 may be equipped with an administrator unit in which the administrator function parts of the information processing units are gathered, outside the information processing unit. Furthermore, as in the case of the administrator function part 110, the communication system 1 can distribute and place a spare of the stateful proxy function part 120 and a spare of the DNS function part 130 outside the information processing unit. Besides, the communication system 1 may be equipped with spares of the respective function parts (the administrator function part 110, the stateful proxy function part 120 and the DNS function part 130) of the information processing unit 10 outside the information processing unit, for example, on a satellite.

### (Operation)

Next, the operation of the abovementioned communication system 1 will be described. First, referring to FIG. 8, information processing unit specification processing according to outside situation information will be described. FIG. 8 is a flowchart for describing the information processing unit specification processing. The example shown by FIG. 8 describes a case of specifying another information processing unit on the basis of time in the place where the information processing unit 10 is installed.

First, the outside situation information acquiring part 113 acquires outside situation information (step S1). For example, the outside situation information acquiring part 113 refers to a clock built in the information processing unit 10 itself and acquires current time (for example, “12:00”).

Next, the administrator function part 110 acquires a condition for another information processing unit to be specified (step S2). For example, the outside situation information acquiring part 113 acquires a night-time period as a condition for another information processing unit. Then, the administrator function part 110 specifies another information processing unit that satisfies the condition acquired at step S2 (step S3). To be specific, the outside situation information acquiring part 113 refers to the time-difference management table 151 (FIG. 4) and specifies the “United Kingdom,” which is a place (a country) where it is in a night-time period when it is “12:00” in Japan.

Next, the administrator function part 110 instructs the specified other information processing unit to execute the communication control processing (step S4). To be specific, the administrator function part 110 refers to information processing unit information of the “United Kingdom” previously stored in the information processing unit management table 161 shown in FIG. 5, and acquires information of an address “yyyy” for communicating with the “information processing unit 30” of the “United Kingdom.” Then, the administrator function part 110 instructs the specified other information processing unit to execute the communication control processing on the user terminals UA1, UA2, . . . . After step S4, the information processing unit specification processing shown in FIG. 8 ends.

Consequently, it is possible to use an information processing unit most of whose equipment becomes idle in a night-time period. Therefore, it is not necessary to spend money on the equipment of the information processing units, it is possible to reduce the cost of each of the information processing units, and it is possible to increase the use efficiency of the information processing units.

Thus, in a case where the information processing unit 10 is normally operating, the information processing unit 10 executes predetermined communication control processing on the user terminals UA1, UA2, . . . (for example, (1) in FIG. 9). On the other hand, in the case of specifying another information processing unit on the basis of acquired outside situation information, the information processing unit 10 instructs the other information processing unit to execute the communication control processing (for example, (2) in FIG. 9). For example, the information processing unit 10 acquires current time “12:00” as outside situation information, and specifies another information processing unit in a place where it is in a night-time period when it is “12:00” in Japan (in the example shown by FIG. 9, the information processing unit 30 of the United Kingdom). In this case, the information processing unit 10 instructs the other information processing unit 30 to execute the communication control processing. Then, the other information processing unit 30 executes the communication control processing on the user terminals UA1, UA2, . . . (for example, (3) in FIG. 9). Therefore, it is possible to use an information processing unit which is not thought to be much used because it is in a night-time period, and securely cause a plurality of user terminals to communicate given information.

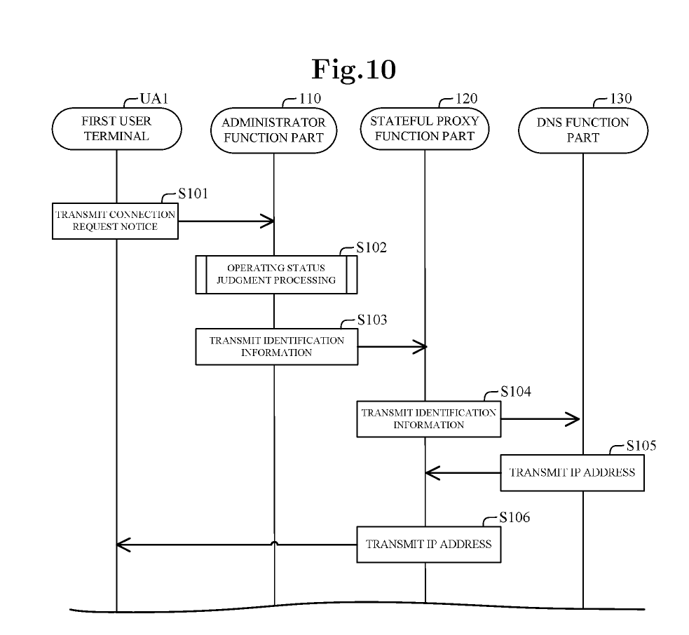

Next, referring to FIG. 10, the communication control processing will be described. As shown in FIG. 10, the first user terminal UA1 transmits a connection request notice including identification information for identifying the second user terminal UA2 (or the relay function part 112) to the administrator function part 110 (step S101).

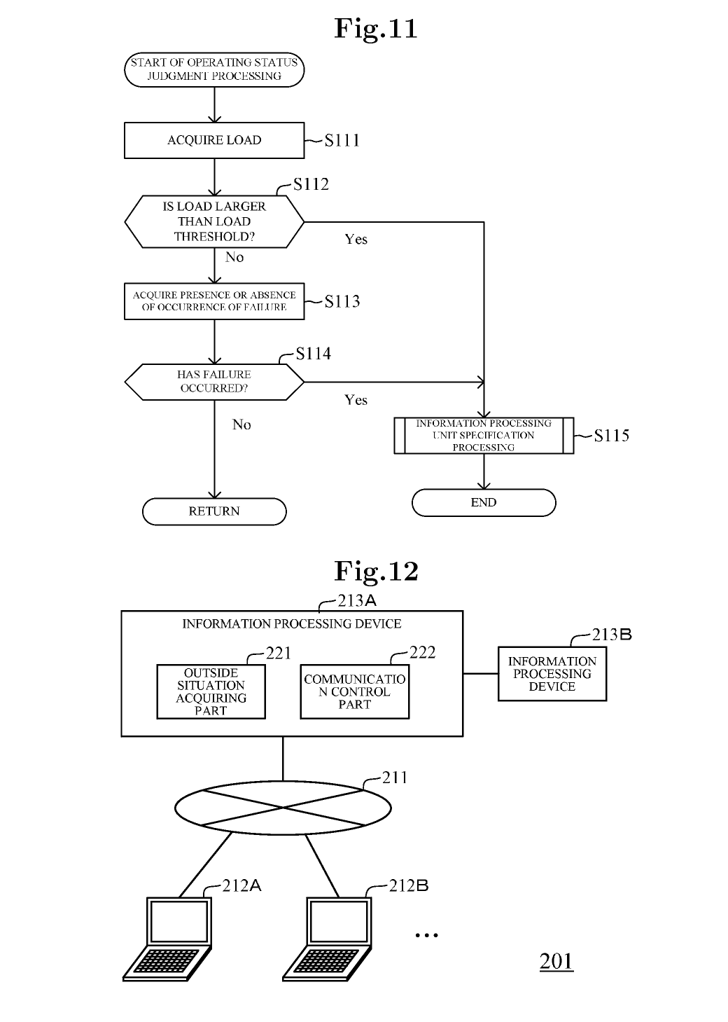

Consequently, the administrator function part 110 receives the connection request notice. Then, the administrator function part 110 executes operating status judgment processing on the connection control part 111 (step S102). The operating status judgment processing will be described referring to FIG. 11.

FIG. 11 is a flowchart for describing the operating status judgment processing. As shown in FIG. 11, the administrator function part 110 first acquires a load on the connection control part 111 (step S111). Subsequently, the administrator function part 110 judges whether or not the acquired load is larger than a preset load threshold (a connection control load threshold) (step S112).

In the case of judging the load is not larger than the load threshold (step S112: No), the administrator function part 110 acquires the presence or absence of occurrence of a failure (detects a failure) of the connection control part 111 (step S113). In a case where it is judged a failure has occurred (step S114: Yes), and in a case where it is judged the load is larger than the load threshold (step S112: Yes), the outside situation information acquiring part 113 executes information processing unit specification processing (step S115). Because the information processing unit specification processing at step S115 is the same as the information processing unit specification processing in FIG. 8, a detailed description thereof will be omitted. Then, after step S115, the operating status judgment processing ends, and the processing shown in FIG. 10 is executed again by another information processing unit (for example, the second information processing unit 20).

In other words, instead of receiving a connection request notice from a user terminal (step S101), the information processing unit (for example, the second information processing unit 20) receives a connection request notice from another information processing unit (for example, the first information processing unit 10). Consequently, the information processing unit (for example, the second information processing unit 20) executes processes at step S102 and later. In a case where there are a plurality of information processing units, the administrator function part 110 transmits a connection request notice to an information processing unit having the smallest load, for example. Therefore, the other information processing unit having received the connection request notice from the information processing unit 10 can omit the operating status judgment processing.

On the other hand, in a case where it is not judged a failure has occurred (step S114: No), the processing proceeds to step S103 in FIG. 10. In other words, in a case where the load on the connection control part 111 is equal to or less than the preset load threshold according to the operating status judgment processing at step S102 and a failure has not occurred in the connection control part 111, the administrator function part 110 transmits identification information included in the connection request notice to the stateful proxy function part 120 (step S103).

Consequently, the stateful proxy function part 120 receives the identification information. Then, the stateful proxy function part 120 transmits the identification information to the DNS function part 130 (step S104).

Consequently, the DNS function part 130 receives the identification information. Then, the DNS function part 130 acquires an IP address stored so as to be linked to the identification information, as a communication destination IP address. Next, the DNS function part 130 transmits the communication destination IP address to the stateful proxy function part 120 (step S105). Meanwhile, in a case where a connection request notice is received from another information processing unit, there is a case where the IP address linked to the identification information does not exist in the DNS function part 130. In a case where the IP address linked to the identification information does not exist in the DNS function part 130, the administrator function part 110 accesses another DNS function part existing outside the information processing unit 10 or a DNS server, and acquires the IP address linked to the identification information.

Consequently, the stateful proxy function part 120 receives the communication destination IP address. Then, the stateful proxy function part 120 transmits the communication destination IP address to the first user terminal UA1 (step S106). Consequently, the user terminal UA1 receives the communication destination IP address. Meanwhile, in a case where a connection request notice is received from another information processing unit, at step S106, the stateful proxy function part 120 transmits the communication destination IP address to the other information processing unit having received the connection request notice. Then, the other information processing unit having received the communication destination IP address transmits (transfers) the communication destination IP address to the user terminal.

Thus, when a load on the information processing unit 10 get increased, and when a failure has occurred in the information processing unit 10, it is possible to use an information processing unit which is not thought to be much used because it is in a night-time period, and securely cause a plurality of user terminals to communicate given information.

### Second Exemplary Embodiment

Next, a communication system according to a second exemplary embodiment of the present invention will be described referring to FIG. 12.

A communication system 201 according to the second exemplary embodiment has a plurality of information processing devices 213 (for example, information processing devices 213A and 213B) each executing communication control processing on user terminals 212A and 212B connected via a network 211, and the communication system includes:

an outside situation information acquiring part 221 (an outside situation information acquiring unit) which acquires outside situation information representing a preset outside situation (for example, current time, an accident, a disaster, an event, and so on) of a place where the information processing device 213A is installed; and

a communication control part 222 (a communication control unit) which instructs so that the communication control processing executed on the user terminals by the predetermined information processing device 213A is executed by the other information processing device 213B, on the basis of the outside situation information acquired by the outside situation information acquiring part 221.

According to this, outside situation information of the place where the information processing device 213A is installed is acquired, and the other information processing device 213B is instructed to execute the communication control processing on the basis of the acquired outside situation information. As a result, it is possible to cause the information processing device 213B having a small load (not much used because an event or the like is not held) to execute the communication control processing. Thus, it is possible to improve the use efficiency of the information processing devices.

Although the present invention is described above referring to the exemplary embodiments, the present invention is not limited to the above exemplary embodiments. The configurations and details of the present invention can be changed and modified in various manners that can be understood by one skilled in the art within the scope of the present invention.

### SUPPLEMENTARY NOTES

The whole or part of the exemplary embodiments disclosed above can be described as the following supplementary notes, but not limited to the below.

### Supplementary Note 1

A communication system having a plurality of information processing devices each executing communication control processing on user terminals connected via a network, the communication system comprising:

an outside situation information acquiring unit which acquires outside situation information representing a preset outside situation of a place where the information processing device is installed; and

a communication control unit which instructs so that the communication control processing executed on the user terminals by a predetermined one of the information processing devices is executed by another one of the information processing devices, on a basis of the outside situation information acquired by the outside situation information acquiring unit.

According to this, on the basis of the outside situation information of a place where an information processing device is installed, another information processing device is instructed to execute the communication control processing. Therefore, it is possible to cause an information processing device which has a small load (which is not much used) to execute the communication control processing. Thus, it is possible to improve the use efficiency of the information processing devices.

### Supplementary Note 2

The communication system according to Supplementary Note 1, wherein:

the outside situation information acquiring unit acquires the outside situation information of the place where the information processing device is installed, as the outside situation information corresponding to the information processing device; and

the communication control unit instructs so that the communication control processing executed on the user terminals by the predetermined information processing device is executed by the other information processing device installed in a different place from a place where the predetermined information processing device is installed, in accordance with at least one of the outside situation information corresponding to the predetermined information processing device and the outside situation information corresponding to the other information processing device.

According to this, an information processing device installed in a different place from the place where the predetermined information processing device is installed is instructed to execute the communication control processing. Therefore, it is possible to securely execute the communication control processing even if, for example, a load on the predetermined information processing device gets increased because of occurrence of a disaster or the like.

### Supplementary Note 3

The communication system according to Supplementary Note 2, wherein the outside situation information acquiring unit acquires the outside situation information that represents an outside situation varying with the place where the information processing device is installed.

According to this, an outside situation varies with a place where an information processing device installed. Therefore, even if an information processing device installed in a certain place cannot execute the communication control processing, an information processing device installed in another place can execute the communication control processing.

### Supplementary Note 4

The communication system according to Supplementary Note 2 or 3, wherein the outside situation information acquiring unit acquires time in the place where the information processing device is installed, as the outside situation information corresponding to the information processing device.

According to this, time is acquired as outside situation information. Therefore, it is possible to instruct another information processing device to execute the communication control processing depending on time, and it is possible to improve the use efficiency of the information processing devices.

### Supplementary Note 5

The communication system according to Supplementary Note 4, wherein in a case where time of the outside situation information corresponding to the predetermined information processing device is in a preset daytime period and time of the outside situation information corresponding to the other information processing device is in a preset night-time period, the communication control unit instructs so that the communication control processing executed on the user terminals by the predetermined information processing device is executed by the other information processing device.

According to this, an information processing device is instructed to execute the communication control processing in a night-time period when a load on the information processing device gets decreased. Thus, it is possible to improve the use efficiency of the information processing devices.

### Supplementary Note 6

The communication system according to any one of Supplementary Notes 2 to 5, wherein the outside situation information acquiring unit acquires information that represents an outside situation having occurred or expected to occur in the place where the information processing device is installed, as the outside situation information corresponding to the information processing device.

According to this, an outside situation having occurred in a place where an information processing device is installed or an outside situation expected to occur in a place where an information processing device is installed is acquired. Therefore, it is possible to instruct another information processing device to execute the communication control processing when a load on the information processing device increases because of the acquired outside situation, and it is possible to improve the use efficiency of the information processing devices.

### Supplementary Note 7

The communication system according to Supplementary Note 6, wherein:

the outside situation information acquiring unit acquires at least one of information representing an event, an accident, an incident and a disaster which have occurred or which are expected to occur in the place where the information processing device is installed, as the outside situation information corresponding to the information processing device; and

in a case where the outside situation information corresponding to the predetermined information processing device falls into information representing a preset instruction target situation and the outside situation information corresponding to the other information processing device does not fall into the information representing the instruction target situation, the communication control unit instructs so that the communication control processing executed on the user terminals by the predetermined information processing device is executed by the other information processing device.

According to this, when an outside situation such as an event, an accident, an incident or a disaster is acquired, another information processing device in which the outside situation has not occurred is instructed to execute the communication control processing. Thus, it is possible to securely execute the communication control processing.

### Supplementary Note 8

An information processing device comprising:

an outside situation information acquiring unit which acquires outside situation information representing a preset outside situation of a place where the information processing device is installed; and

a communication control unit which instructs so that communication control processing executed by the information processing device on user terminals connected via a network is executed by another information processing device, on a basis of the outside situation information acquired by the outside situation information acquiring unit.

### Supplementary Note 9

An information processing method comprising:

acquiring outside situation information representing a preset outside situation of a place where an information processing device is installed; and

instructing so that communication control processing executed by the information processing device on user terminals connected via a network is executed by another information processing device, on a basis of the acquired outside situation information.

### Supplementary Note 10

A computer program comprising instructions for causing an information processing device to realize:

an outside situation information acquiring unit which acquires outside situation information representing a preset outside situation of a place where the information processing device is installed; and

a communication control unit which instructs so that communication control processing executed by the information processing device on user terminals connected via a network is executed by another information processing device, on a basis of the outside situation information acquired by the outside situation information acquiring unit.

The program described in the exemplary embodiments and supplementary note is stored in a storage device or recorded on a computer-readable recording medium. For example, the recording medium is a portable medium such as a flexible disk, an optical disk, a magneto-optical disk and a semiconductor memory.

Although the present invention has been described above referring to the exemplary embodiments, the present invention is not limited to the exemplary embodiments. The configurations and details of the present invention can be changed and modified in various manners that can be understood by one skilled in the art within the scope of the present invention.

The present invention is based upon and claims the benefit of priority from Japanese patent application No. 2012-257615, filed on Nov. 26, 2012, the disclosure of which is incorporated herein in its entirety by reference.

### DESCRIPTION OF NUMERALS

1 communication system
10 first information processing unit
11, 12 information processing device
20 second information processing unit
21, 22 information processing device
51, 61 storage device
110 administrator function part
111 connection control part
112 relay function part
113 outside situation information acquiring part
120 stateful proxy function part
130 DNS function part
201 communication system
211 network
212 user terminal
213 information processing device
221 outside situation information acquiring part
222 communication control part

1. A communication system having a plurality of information processing devices each executing communication control processing on user terminals connected via a network, the communication system comprising:
an outside situation information acquiring unit which acquires outside situation information representing a preset outside situation of a place where the information processing device is installed; and
a communication control unit which instructs so that the communication control processing executed on the user terminals by a predetermined one of the information processing devices is executed by another one of the information processing devices, on a basis of the outside situation information acquired by the outside situation information acquiring unit.

2. The communication system according to claim 1, wherein:
the outside situation information acquiring unit acquires the outside situation information of the place where the information processing device is installed, as the outside situation information corresponding to the information processing device; and
the communication control unit instructs so that the communication control processing executed on the user terminals by the predetermined information processing device is executed by the other information processing device installed in a different place from a place where the predetermined information processing device is installed, in accordance with at least one of the outside situation information corresponding to the predetermined information processing device and the outside situation information corresponding to the other information processing device.

3. The communication system according to claim 2, wherein the outside situation information acquiring unit acquires the outside situation information that represents an outside situation varying with the place where the information processing device is installed.

4. The communication system according to claim 2, wherein the outside situation information acquiring unit acquires time in the place where the information processing device is installed, as the outside situation information corresponding to the information processing device.

5. The communication system according to claim 4, wherein in a case where time of the outside situation information corresponding to the predetermined information processing device is in a preset daytime period and time of the outside situation information corresponding to the other information processing device is in a preset night-time period, the communication control unit instructs so that the communication control processing executed on the user terminals by the predetermined information processing device is executed by the other information processing device.

6. The communication system according to claim 2, wherein the outside situation information acquiring unit acquires information that represents an outside situation having occurred or expected to occur in the place where the information processing device is installed, as the outside situation information corresponding to the information processing device.

7. The communication system according to claim 6, wherein:
the outside situation information acquiring unit acquires at least one of information representing an event, an accident, an incident and a disaster which have occurred or which are expected to occur in the place where the information processing device is installed, as the outside situation information corresponding to the information processing device; and
in a case where the outside situation information corresponding to the predetermined information processing device falls into information representing a preset instruction target situation and the outside situation information corresponding to the other information processing device does not fall into the information representing the instruction target situation, the communication control unit instructs so that the communication control processing executed on the user terminals by the predetermined information processing device is executed by the other information processing device.

8. An information processing device comprising:
an outside situation information acquiring unit which acquires outside situation information representing a preset outside situation of a place where the information processing device is installed; and
a communication control unit which instructs so that communication control processing executed by the information processing device on user terminals connected via a network is executed by another information processing device, on a basis of the outside situation information acquired by the outside situation information acquiring unit.

9. An information processing method comprising:
acquiring outside situation information representing a preset outside situation of a place where an information processing device is installed; and
instructing so that communication control processing executed by the information processing device on user terminals connected via a network is executed by another information processing device, on a basis of the acquired outside situation information.

10. A non-transitory computer-readable medium storing a computer program comprising instructions for causing an information processing device to realize:
an outside situation information acquiring unit which acquires outside situation information representing a preset outside situation of a place where the information processing device is installed; and
a communication control unit which instructs so that communication control processing executed by the information processing device on user terminals connected via a network is executed by another information processing device, on a basis of the outside situation information acquired by the outside situation information acquiring unit.
